(19) United States
(12) Patent Application Publication
(10) Pub. No.: US 2019/0298616 A1
(43) Pub. Date: Oct. 3, 2019

(54) Thermochromic Baby Bottle and Method of Using the Same

(71) Applicant: Susana Quintero, Downey, CA (US)

(72) Inventor: Susana Quintero, Downey, CA (US)

(21) Appl. No.: 15/942,059

(22) Filed: Mar. 30, 2018

(51) Int. Cl. A61J 9/02; A61J 9/06; A61J 11/00; A61J 11/04

(52) U.S. Cl. CPC A61J 9/02; A61J 9/0623; A61J 2200/72; A61J 11/008; A61J 11/04; A61J 11/005

(57) ABSTRACT

A thermochromatic baby bottle for receiving and dispensing fluids to infants and babies along with a method of use comprises a bottle, a collar, a nipple, a cap, a ribbed sleeve, and a wings handle, any or all of which may have one or more thermochromic elements disposed on, in, or attached to them. A thermometer outline on the side of the bottle, a thermochromatic sticker, one or more raised thermochromic portions of the bottle shaped as rings encircling the bottle, or hidden shapes that become visible when one or more thermochromic elements are engaged, are all non-limiting examples of the one or more thermochromic elements. The bottle may have one or more narrow or graduated portions, one or more non-thermochromic design elements, or any other ornamentation may be disposed on the bottle's exterior as well.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to infant and baby feeding systems and, more particularly, to a baby bottle having thermochromic properties, along with a method of using the same.

### BACKGROUND

Infants and babies often require warm fluids for feeding, comfort, and the like. Proper feeding of an infant or baby often requires a bottle to deliver these warm fluids. Consequently, many methods of warming a baby bottle are known, and many baby bottles configured for use with warm fluids are also known.

Sometimes, however, a caregiver may wish to know whether or not the fluid inside the baby bottle is above a particular temperature. Relatedly, many methods of ascertaining the temperature of a fluid inside a baby bottle are known, including but not limited to thermometers integrated within the baby bottle, or baby bottles having removable thermometer elements. In some instances, a caregiver may not be able to use a thermometer, or may not wish to read a precise temperature output simply to know whether or not the fluid is warm enough. In such instances, a “yes/no” indicator is helpful.

One convenient yes/no indicator is a color change. Color changes as indicators are helpful because they can be easily detected and are immediately understandable. Unsurprisingly, some baby bottles that change color based on their temperature are known in the art. However, these known solutions fail to provide for the robust set of thermochromic baby bottle features provided in the present invention.

Attempts at thermochromic baby bottle solutions have been made. For example, U.S. Patent Application Publication No. 2015/0250683, incorporated by reference in its entirety herein, appears to disclose a removable, protective, heat sensitive and color changing silicone sleeve for baby feeding glass bottles or containers. While this disclosure does provide for a removable option, it fails to provide for a tactile component integrated within a visual thermochromic element.

Another example may be seen with respect to U.S. Pat. No. 4,919,983, incorporated by reference in its entirety herein, which generally shows a color-changing baby bottle container. While this disclosure does provide a thorough thermochromism wherein the thermochromic elements are integrated into the bottle structure, it fails to provide that those thermochromic elements form a discernible pattern, shape, letter, symbol, or other visual feature when warmed to the color-changing state.

Yet another example may be seen with respect to U.S. Patent Application Publication No. 2012/0152780, incorporated by reference in its entirety herein, which generally discloses a bottle having a thermochromic fluid level meter, wherein as the temperature of the bottle changes from the addition of warm (or cool) liquid, the meter rises or lowers accordingly. While this disclosure does provide a user with graduated information concerning not only the presence of a warm (or cool) liquid but an idea of how much of the liquid is in the bottle, its design lacks complexity and utility in different applications such as, for example, if the bottle were tilted.

As can be seen, none of these in existence comprise beneficial characteristics described in the following disclosure. Thus, there remains a need for a thermochromic baby bottle that provides multiple tactile and visual components, and a method of using the same.

### SUMMARY

The present disclosure is directed to an improved baby bottle that may provide for thermochromatic temperature indications, in addition to other properties.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

The present invention comprises a thermochromatic baby bottle for receiving and dispensing fluids to infants and babies, along with a method of use. In some embodiments, the thermochromatic bottle may comprise a bottle configured to hold infant or baby formula. The bottle may be cylindrical, hourglass-shaped, or any other shape and may have at least one top opening. In some embodiments, the bottle may also comprise a collar. A removable lid, in some embodiments shaped as a nipple or nipple variant may be configured to attach to the top opening of the bottle. A cap may be configured to cover the lid. A ribbed sleeve may be provided that removably attaches overtop of the bottle. In some embodiments, the ribbed sleeve portion may be permanently affixed to the exterior of the bottle. In some embodiments, the ribbed sleeve portion may comprise a portion of the bottle. A wings-shaped handle addition may be provided that may attach, by way of example threadedly attach, between the top of the bottle and the lid, wherein the wings handle element may be shaped so as to enable a baby to hold the present invention.

In some embodiments, some of all of the bottle, the collar, the nipple, the cap, the ribbed sleeve, and the wings handle may have one or more thermochromic elements disposed on, in, or attached to them. A thermometer or thermometer outline on the side of the bottle, a thermochromatic sticker, one or more raised thermochromic portions of the bottle shaped as rings encircling the bottle, or hidden shapes that become visible when one or more thermochromic elements are engaged, are all non-limiting examples of the one or more thermochromic elements. The bottle itself may have one or more narrow or graduated portions, one or more non-thermochromic design elements, or any other ornamentation may be disposed on the bottle's exterior as well.

It is contemplated that the present invention may be used in conjunction with various methods for collecting and dispensing infant and baby formula. By way of illustration and not of limitation, one or more methods of the present invention may provide that a user first warm a liquid, then add it into the center of the bottle. The user may then examine the present invention's thermochromic element(s). Based on the temperature of the fluid, the thermochromic element(s) may change color, and may alert the user to the liquid's temperature. Assuming the thermochromic element(s) indicates that the liquid is of the correct temperature, the user may then screw on the nipple (over the wings if so desired), and administer the fluid to an infant or baby. In other embodiments, the method may comprise warming a liquid while the liquid is already in the bottle, and use the present invention's thermochromic properties to indicate when the fluid inside the present invention has reached an appropriate temperature.

It is contemplated that one or more embodiments of the present invention may comprise one or more thermochromic elements that may be configured to change color when the present invention contains a liquid that is heated above a particular temperature. By way of illustration and not limitation, one or more thermochromic elements of the present invention may change color when an infant formula inside the bottle has been warmed to a temperature suitable for an infant's consumption. Another non-limiting example may comprise a thermochromic element configured in a recognizable shape that may change color when an infant formula inside the bottle has been warmed to a temperature suitable for an infant's consumption. It is contemplated that the color change displayed by the one or more thermochromic elements in one or more embodiments disclosed herein may provide a user, such as a mother, with visual confirmation of the infant formula's sufficient temperature, and thereby also giving the mother peace of mind that the infant, baby, or child is receiving formula at an appropriate temperature.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a front perspective view of a thermochromic baby bottle in accordance with an embodiment of the invention.

FIG. 2 shows a front perspective view of a thermochromic baby bottle in accordance with an embodiment of the invention.

FIG. 3A shows an exploded view of a thermochromic baby bottle in accordance with an embodiment of the invention.

FIG. 3B shows an exploded view of a thermochromic baby bottle in accordance with an embodiment of the invention.

FIG. 3C shows an exploded view of a thermochromic baby bottle in accordance with an embodiment of the invention.

FIG. 3D shows an exploded view of a thermochromic baby bottle in accordance with an embodiment of the invention.

FIG. 4 illustrates an exemplary method of use for a thermochromic baby bottle in accordance with an embodiment of the invention.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

According to an example embodiment, a thermochromatic bottle is provided. The thermochromatic bottle may comprise a bottle having a top opening, a neck (or “collar”), a nipple (or “nipple”), a cap, a ribbed sleeve, and a wings handle, in addition to other elements. The bottle may be of one piece or of a separate piece from the collar. In some embodiments, one or more elements may threadedly attach to one another. In some embodiments, one or more elements may be permanently affixed to one another, or may be of one piece with each other.

One or more of the bottle, collar, lid, cap, ribbed sleeve, and wings handle, or other element(s), may be comprised of a thermochromic material. In some embodiments, one or more of the bottle, collar, lid, cap, ribbed sleeve, and wings handle, or other element(s), may be comprised of a substantially transparent material. In some embodiments, one or more of the bottle, collar, lid, cap, ribbed sleeve, and wings handle, or other element(s), may be comprised of a combination of a thermochromic material and a substantially transparent material.

In some embodiments, the nipple may be configured as a nipple through which an infant or child may suckle fluids. In some embodiments, the nipple may be configured in a natural shape, so as to approximate the curvatures of a human nipple, and in some embodiments, prevent nipple confusion, as that term is known in the art. In other embodiments, the nipple may be shaped as an un-stylized or traditional artificial nipple, or as any shape nipple known in the art. As well, the teat of the nipple may be longer or shorter, wider or narrower in some embodiments than others.

In some embodiments, the one or more thermochromic materials may be configured to provide a visual indication of a change in one or more temperature conditions. In some embodiments, the visual indication may comprise a sequence wherein a thermochromic material may change colors, transition from a first color to a second color, or become transparent in response to a raising or lowering of the temperature of the thermochromic material. In embodiments having more than one thermochromic material, the properties of the thermochromic materials may differ, such as but not limited to differences as to type(s), color(s), set point(s), and/or end point(s) of the thermochromic materials. A “visual indication” may at times herein be referred to as a “color change,” which may refer to a change in color that this perceptible by the human eye and/or to a change from an opaque state to a transparent state.

By way of non-limiting example, a first temperature condition may comprise the temperature of a fluid within the thermochromatic bottle, a second temperature condition may comprise the temperature of a user's body part such as an infant's mouth, and a third temperature condition may comprise the temperature of ambient air surrounding the present invention.

Accordingly, in some embodiments, any element possessing thermochromic material, including but not limited to the ribbed sleeve, lid, collar, and bottle, may provide a visual indication of a change in one or more temperature conditions.

By way of illustration, the bottle may change colors, transition from a first color to a second color, or become transparent when a user heats a liquid within the thermochromatic bottle to a temperature of 80 degrees Fahrenheit. Or for example, the nipple may transition from a first color to a second color, or become transparent when an infant's mouth causes the nipple to reach a temperature above a certain threshold, such as for example would be sufficient to indicate that the infant has an illness. Or for instance, the ribbed sleeve may transition from a first color to a second color, or become transparent when a user's hand transfers heat to the ribbed sleeve sufficient to raise the temperature of the ribbed sleeve above a certain threshold.

Relatedly, the elements of the present invention may comprise different thermochromic materials. By way of illustration and not limitation, a bottle may comprise a first thermochromic material, a ribbed sleeve may comprise a second thermochromic material, a collar may comprise a third thermochromic material, and a nipple may comprise a fourth thermochromic material. In such an embodiment, or in any embodiment having more than one thermochromic material, the properties of one or more thermochromic materials may differ as discussed elsewhere herein. For example, the colors, set points, and end points of the first thermochromic material may differ from those of the second thermochromic material.

Moreover, in some embodiments, any element including but not limited to the ribbed sleeve, lid, collar, and bottle may comprise more than one thermochromic material. For example, any such element may comprise both a first thermochromic material and a second thermochromic material. Or, any such element may comprise three or more thermochromic materials.

One non-limiting example of the foregoing may comprise an embodiment wherein a ribbed sleeve comprises four concentric raised rings, wherein each raised ring is comprised of a different thermochromic material. Or, a bottle may comprise a first thermochromic material at its lowest point, a second thermochromic material above the first thermochromic material, and a third thermochromic material above the second thermochromic material and abutting the collar.

Generally, the thermochromic material may be thermochromic liquid crystals (TLCs), thermochromic leuco dyes, or a combination thereof. In some embodiments, the thermochromic leuco dyes may comprise two or more thermochromic leuco dye layers. In some embodiments, each thermochromic leuco dye layer may have a different color, a different set point (or “activation temperature”), and/or a different end point.

It is therefore contemplated that any element of the present invention may comprise a first thermochromic material, a second thermochromic material, and/or a third or more thermochromic material, wherein each thermochromic material may comprise any type of thermochromic liquid crystal and/or any type of leuco dye, wherein the thermochromic materials may have any different color, any different set point or activation temperature and any different end point.

The present invention may also comprise thermochromic materials configured such that when the thermochromic material undergoes a visual indication, the thermochromic material appears to the human eye as a pleasant shape or design, such as an animal, a swirl, or a sun. These thermochromic features may be configured as raised or depressed portions of an element, or as embedded features within an element. For example, in the bottle, a thermochromic feature may comprise a thermochromic element that may, at room temperature, be visually indistinct from the bottle, but that may become visually distinct when the bottle is warmed to a particular temperature.

Thermochromism is the property wherein a material's color may change, transition from one color to another, or disappear, in response to the addition or removal of thermal energy. Such thermal changes can change the molecular geometries of certain materials to reflect or absorb certain wavelengths of light, or cause the material to become transparent.

Generally, two types of thermochromic materials are known: thermochromic liquid crystals (TLCs) and thermochromic leuco dyes (“leuco dyes”). Both TLCs and leuco dyes may be industrially, commercially, or privately produced as microcapsule suspensions having particles sized approximately 3-5 μm. TLCs may be manufactured in the form of microscopic spheres embedded in a plastic or polymer. TLCs and leuco dyes may be produced in various configurations or combinations in order to affect a desired color change at a desired temperature.

The color change of a thermochromic material generally transpires across an interval of activity. Below a particular temperature, the thermochromic material undergoes no color change. However, at the “activation temperature” or “set point,” the color begins to change. At the “end point,” the thermochromic material ceases changing color, or has substantially completed the color change and remains in one state, such as but not limited to a particular color, translucence, or black. In some embodiments, a color change may be said to be substantially complete when 95% of the desired color change has occurred. In some embodiments, the process of a color change may occur exponentially as the temperature rises from the set point to the end point. By way of example, in some color changes the color change may be marginally perceptible at the set point, but may become an exponential color change as the temperature nears the end point.

Thermochromic liquid crystals (TLCs) generally offer more precise responses to color changes than leuco dyes, and are generally capable of transitioning between a range of colors along a color gradient. For example, some TLCs may be generally formulated to change colors anywhere in the range of −22° F. to +248° F. (−30° C. to 120° C.) and may be sensitive enough to change colors in response to temperature changes as small as 0.2° F. Thus, in some embodiments, TLCs may be configured to change color in a manner that is discernible to the human eye in increments as small as 0.2° F.

As the temperature of the TLCs changes, so does the spacing between the liquid crystals, causing the TLCs to reflect light of a different wavelength and therefore causing the human eye to perceive a different color. Thus, under multiple temperature conditions, a material containing TLCs could appear to have a variety of different colors. For example, a TLC may have a set point of hypothetically 80.0 F., may display a first color at 85.0 F., may display a second color at 90.0 F., and a third color at 95.0 F. (here the end point), after which the TLC may no longer change color. Another example could have a set point of 80.0 F., a first color change at 80.2 F., a second color change at 80.4 F., and an end point of 80.6 F. Of course, the 5.0 F. and 0.2° F. increments are used herein purely for example, and that the thermochromic materials of the present invention TLCs may be configured to change colors in larger or smaller increments, and also in increments that vary in magnitude from step to step.

Any element of the present invention may comprise one or more types of TLCs as constituent components of the element, as one or more painted-on layers of the element, one or more stickers applied to the element, or any other way of affixing one or more TLCs on or within an element.

Some non-limiting examples of suitable thermochromic liquid crystals include cholesteric liquid crystals, chiral nematic liquid crystals, smectic liquid crystals, cyanobiphenyls and combinations thereof. Some non-limiting examples of suitable cholesteric liquid crystals include cholesterol esters (e.g., cholesteryl nonanoate and cholesteryl benzoate), cholesterol alkyl carbonates (e.g., cholesteryl oleyl carbonate), cholesterol chloride, and combinations thereof.

Leuco dyes are temperature-sensitive dyes (or inks) that may also change color in response to a change in temperature. The process for some leuco dyes, including those contemplated for use with the present invention, involves a combination of thermochromism and halochromism (color change via pH change).

When used as microcapsules, the leuco dye generally consists of a dye molecule (for example crystal violet lactone), a weak acid, a dissociable salt and a solvent inside the microcapsule. At room temperature, generally, the solvent such as for example dodecanol, is a sonipple and the microcapsule is in a first color state, which for this example will be a leuco (colorless) state, such as a lactone leuco form. However, when heat is applied, the solvent melts, the dissociable salt dissociates and lowers the pH of the microcapsule, thereby protonating the dye molecule (here protonating the dye molecule opens the lactone ring), which changes the absorption spectrum of the dye molecule, which in turn changes the overall visual appearance of the microcapsule from a leuco form to a colored form (here deep violet). Collectively, all affected and similarly constructed microcapsules together form a color change visible to the naked eye.

Generally speaking, therefore, leuco dyes tend to have a binary “either-or” color change, as compared to the color change gradient that TLCs display. However, in some embodiments, the present invention may comprise multiple layers or sections of different leuco dye microcapsules so that, collectively, a spectrum of colors and color changes is possible. Also, whereas TLCs can change colors in response to 0.2 F. temperature intervals, leuco dyes generally require at least 5.4 F. between set point and end point to display a color change. As a general rule, leuco dyes may be formulated to change colors anywhere in the range of 23° F. to 140° F. (−5° C. to 60° C.).

Those of skill in the art will recognize that a leuco dye can change from colored to colorless, colorless to colored, or from one color to another via similar sequences. Indeed, any chemical construction within a microcapsule or other leuco dye mechanism known in the art is herein contemplated as well. Any element of the present invention may comprise one or more types of leuco dyes as constituent components of the element, as one or more painted-on layers of the element, one or more stickers applied to the element, or any other way of affixing one or more leuco dyes on or within an element.

Some non-limiting examples of leuco dye molecules include spirolactones, fluorans, spiropyrans, fulgides and combinations thereof. Some non-limiting examples of suitable spiropyrans include 1′,3′,3′-trimethyl-6-nitrospiro[2H-benzo-pyran-2,2′-indoline]; 3-ethyl-3-phenyl-5′bromo-6′-nitro-8′-methoxy-indolinobenzospiropyran; 3-ethyl-5-chloro-indolino benzospiropyran; 3-ethyl-5′-bromo-6′-nitro-8′-methoxy-indolino benzospiropyran; 3-ethyl-5′-nitro-8′-methoxy-indolino benzospiropyran; 3-ethyl-6′,8′-dinitro-indolino benzospiropyran; 8,8′-dinitro-3,3′-spirobi[3H-naphtho[2,1-b]pyran]; 3-phenyl-8-methoxy-8′-nitro-dibenzospiropyran; 3-phenyl-6′nitro-8′iodo-dibenzospiropyran; 3-phenyl-6′-nitro-dibenzospiropyran; 3,5,3′-trimethyl-6′-nitro-benzoxazolino-benzospiropyran; 3,3′-dimethyl-6′-nitro-benzoxazolino-benzospiropyran and combinations thereof.

Other non-limiting examples of leuco dyes include 4,4′-Bis(dimethylamino)benzhydrol (Michler's hydrol), Crystal Violet Carbinol, Malachite Green carbinol, N-(2,3-dichlorophenyl)-leuco auramine, N-benzoyl auramine, N-acetyl auramine, N-phenyl auramine, Rhodamine B lactam, 2-(phenyliminoethylidene)-3,3-dimethyl-indoline, N,3,3-trimethyl-indolinobenzo-spiropyran, 8′-methoxy-N,3,3-trim ethylindolino-spiropyran, 3-diethylamino-6-methyl-7-chloro-fluoran, 3-diethylamino-7-methoxy-fluoran, 3-dimethylamino-6-benzyloxy-fluoran, 1,2-benzo-6-diethylaminofluoran, 3,6-di-p-toluidino-4,5-dimethylfluoran-phenylhydrazide-gamma.-lactam, 3-amino-5-phenyl-8-methyl-fluoran, 2-methyl-3-amino-6-methyl-7-methyl-fluoran, 2,3-butylene-6-di-n-butylamino-fluoran, 3-diethylamino-7-anilino-fluoran, 3-diethylamino-7-(p-toluidino)-fluoran, 7-acetamino-3-diethylamino-fluoran, 2-bromo-6-cyclohexylamino-fluoran, 2,7-dichloro-3-methyl-6-n-butylamino-fluoran and combinations thereof.

Some other non-limiting examples of leuco dyes include diaryl phthalides, polyaryl carbinols, leuco auramines, lactum leuco compounds, indolines, spiropyrans and fluoranes, and one or more electron-donating chromatic organic compounds selected from the group consisting of diaryl phthalides, indolyl phthalides, polyaryl carbinols, leuco auramines, acyl auramines, aryl auramines, Rhodamine B lactam, indolines, spiropyrans and fluorans, and one or more electron-donating, chromatic organic compounds selected from the group consisting of diaryl phthalides, aryl phthalides, indolylphthalides, polyarylcarbinols, leucoauramines, acrylauramines, arylauramines, rhodamine B lactams, indolines, spiropyrans, fluorans, thiofluorans, phenothiazines, triphenylmethanes, diarylarylfurans, spiroxanthenearylfurans, and chromenoindoles.

Some other non-limiting examples of leuco dyes include 3-amino-5-methylfluoran, 3-diethylamino-6-methyl-7-dimethylamino-thiofluoran, 3-diethylamino-7-dibenzylamino-thiofluoran, 3,3-bis(1-ethyl-2-methyl-3-yl)phthalide, 3,3-bis(2-phenylindol-3-yl)phthalide, 3-(4-diethylaminophenyl)-3-(1-ethyl-2-methylindol-3-yl)phthalide, 3-(4-di-n-butylaminophenyl)-3-(2-phenylindol-3-yl)phthalide, 3-(duroridine-6′-yl)-3-(1′-methyl-2′-phenylindol-3′-yl)phthalide, 3-(1′,2′,3′,4′-tetrahydroquinolin-6′-yl)3-(1′-ethyl-2′-methyl-indol-3′-yl)phthalide, 3,3-bis(1-ethyl-<BR><BR><BR>2-methyl -indol-3-yl)-7-azaphthalide, 3-(diphenylamino)-3-(1-ethyl-2-methylindol-3-yl)phthalide, 3-[N-(4-ethoxyphenyl)N-phenyl-amino]-3-(1-ethyl-2-methylindol-3-yl)phthalide, 3-[4-(dimethylamino)phenyl]-3-[N,N-bis-(4-octylphenyl)amino]phthalide, 3-[4-(ethylbenzylamino)phenyl]-3-[N-(4-ethoxyphenyl)N-phenylamino]phthalide, 2,2-bis(p-N,N-dimethylaminophenyl)2-H-naphtho[1,8-bc]furan, spiro-3,6-bis(dimethylamino)xanthen-9,2-(2H)-naphtho[1,8-bc]furan, 6,6-bis(4-dimethylaminophenyl)-6H-chromeno[4,3-b]indole and the like.

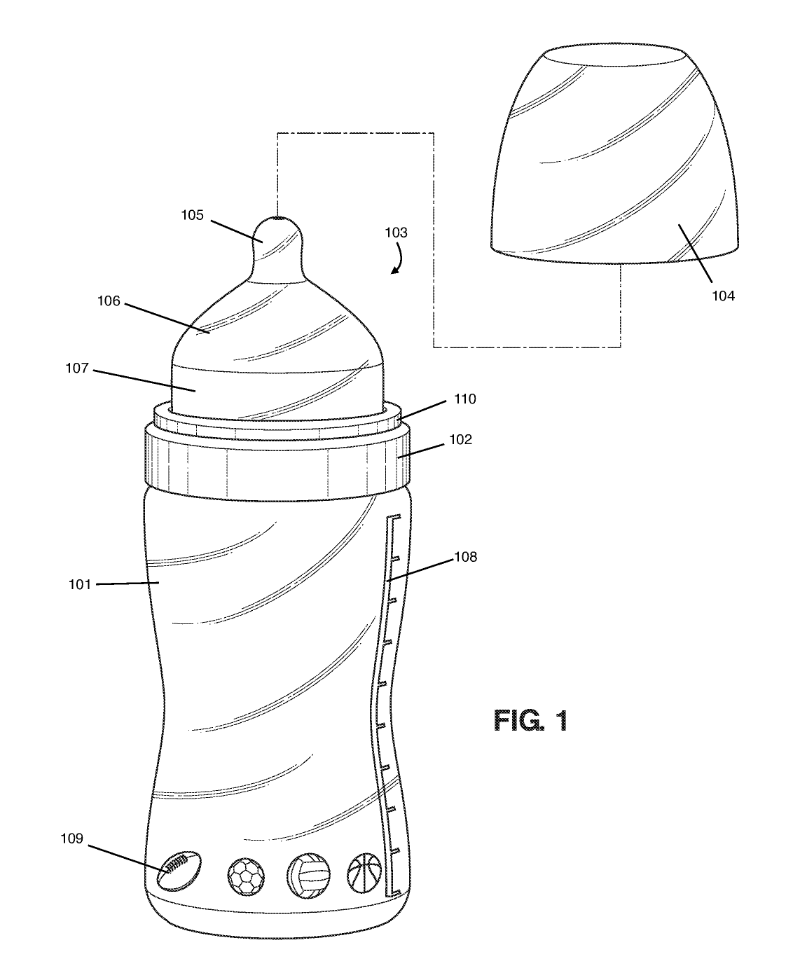

With reference to FIG. 1, a front perspective view of a thermochromic baby bottle in accordance with an embodiment of the invention is shown. In the embodiment depicted, a viewer may perceive thermochromic baby bottle 100, bottle 101, collar 102, nipple 103, cap 104, nipple tip 105, nipple neck 106, nipple base 107, graduated indicator 108, design element 109, and collar upper portion 110.

Bottle 101 may be generally cylindrical, and may have at least one central cavity and an opening in its top end or top side. In some embodiments, bottle 101 may comprise two or more cavities or central cavities. In some embodiments, bottle 101 may comprise two or more connected cavities. In some embodiments, bottle 101 may be hourglass-shaped. In other embodiments, bottle 101 may be shaped as a cylinder, or a cylinder with one or more narrower or wider portions. In other embodiments, bottle 101 may be spherical. As well, bottle 101 may in some embodiments be longer or shorter than shown in FIG. 1. Bottle 101 may be of any shape known in the art. Bottle 101 may have one or more contours or protrusions shaped to enable a hand to grasp bottle 101 more easily, such as but not limited to one or more finger grooves. Additionally, bottle 101 in some embodiments may comprise an animal shape such as but not limited to a monkey, lion, rabbit or a dog, an object such as a banana, tree, flower, star, sun, or moon, a rocket ship or train. Any object commonly known to be appealing to children is contemplated herein as a shape for bottle 101 or any other element of the present invention.

Bottle 101 may be comprised of any material known in the art, such as but not limited to glass, any plastic, a disposable material, stainless steel, carbon fiber, wood, ceramic, or a combination of any such material.

In some embodiments, two or more bottles 101 may be provided. In such embodiments, the two or more bottles 101 may be connected, disconnected, attachable and detachable, stackable, having one or two fluid repositories, or any other configuration known in the art.

Bottle 101 may comprise one or more thermochromic elements such as but not limited to one or more thermochromic liquid crystals, leuco dyes, or a combination of thermochromic liquid crystals and leuco dyes. In an embodiment wherein bottle 101 has only one thermochromic element, the thermochromic element may be disposed on or in any portion of bottle 101, such as but not limited to a band within bottle 101, all but a portion of bottle 101, an outline of a shape or design on bottle 101.

In embodiments wherein two or more thermochromic elements are provided for bottle 101, the two or more thermochromic elements may comprise two separate thermochromic elements having the same properties and disposed separately on or in bottle 101. In such embodiments, the positioning of the two or more thermochromic elements may provide for one or more visual indications, such as the presence of a liquid having at least one temperature property, such as warmth, within bottle 101, and how much of the available room within bottle 101 is taken up by the liquid.

In other embodiments, one or more of the two or more thermochromic elements disposed on or in bottle 101 may have different properties than another of the two or more thermochromic elements and may also be disposed separately. In embodiments having two or more thermochromic elements disposed on or in bottle 101, the properties of the two or more thermochromic elements may be selected to offer a continuum of color changes. By way of illustration and not limitation, were bottle 101 to have three different thermochromic elements, the first thermochromic element may exhibit a color change to a light first color, the second thermochromic element may exhibit a color change to a medium-dark second color, and the third thermochromic element may exhibit a color change to a dark third color. By way of illustration, the first color could be light blue, the second color could be medium-dark blue, and the third color could be dark blue. Any number of thermochromic elements are contemplated having any color properties, such as four to twenty thermochromic elements, twenty to a hundred thermochromic elements, or more than a hundred thermochromic elements, disposed on or in any element of thermochromic baby bottle 100.

Notably, any element of thermochromic baby bottle 100, including but not limited to bottle 101, may comprise the one or more thermochromic elements and properties as well as the two or more thermochromic elements described above for bottle 101 or for any other element of the present invention.

As shown in FIG. 1, collar 102 may generally comprise a separate element that removably attaches to the top portion of bottle 101. In such embodiments, collar 102 may threadedly attach to bottle 101, or may attach via snap attachment, magnetic attachment, or a different removable attachment element. However, in some embodiments, collar 102 may comprise the upper portion of bottle 101.

Remaining with FIG. 1, nipple 103 may be shaped as a natural-shaped nipple, such as by way of illustration and not limitation an orthodontic-shaped nipple 103, a round shape nipple 103, a bell-shaped nipple 103, a dome-shaped nipple 103, and may be configured for slow flow, medium flow, or fast flow. In other embodiments, nipple 103 may be shaped as an object other than a nipple, such as by way of illustration, a spout, two nipples, an anatomically correct nipple, a silicon spout, a tube, a pacifier, or any other fluid conduit known in the art. Additionally, nipple 103 may be wider or narrower, longer or shorter than shown in FIG. 1. Additionally, nipple 103 may be angled relative to bottle 101 and/or collar 102. For example, so as to enhance the flow of fluids through the present invention or to make the fluid less aerated, some embodiments may be configured such that the nipple tip 105 may be closer to one side of nipple neck 106, nipple base 107, collar 102, or bottle 101 than the other side of nipple neck 106, nipple base 107, collar 102, or bottle 101.

As well, one or more of nipple 103, cap 104, nipple tip 105, nipple neck 106, nipple base 107 may be of different size or shape. In embodiments wherein two or more bottles 101 may be provided, one or more of nipple 103, cap 104, nipple tip 105, nipple neck 106, nipple base 107 may be of different size or shape than any other of one or more of nipple 103, cap 104, nipple tip 105, nipple neck 106, nipple base 107. Generally, nipple 103, nipple tip 105, nipple neck 106, and nipple base 107 may be comprised of latex, elastomer, a soft plastic, silicone, synthetic elastomer, or any other material known in the art.

In some embodiments, nipple 103, nipple tip 105, nipple neck 106, and/or nipple base 107 may be comprised of one or more thermochromic elements. For example, in some embodiments nipple 103, nipple tip 105, nipple neck 106, and/or nipple base 107 may provide for a thermochromic element configured to change color when a fluid such as infant formula flows through nipple 103, nipple tip 105, nipple neck 106, and/or nipple base 107 at a particular temperature. In some embodiments, one or more of nipple 103, nipple tip 105, nipple neck 106, and/or nipple base 107 may provide for different thermochromic elements such that nipple 103, nipple tip 105, nipple neck 106, and/or nipple base 107 may be configured to give more specific visual information to a user as to the approximate or even nearly-exact temperature of the fluid flowing through nipple 103, nipple tip 105, nipple neck 106, and/or nipple base 107.

With continued respect to FIG. 1, in some embodiments cap 104 may be generally configured as a cylinder designed to fit overtop of nipple 103 and removably attach to collar 102 or, in some embodiments, directly to bottle 101. As may be imagined, it is contemplated that cap 104 may be of any shape known in the art, and may in some embodiments, for non-limiting example, be shaped as a pyramid, a sphere, a cartoon character, a ring, a rainbow, or any other shape known in the art. It is contemplated that the shape of cap 104 may, in some embodiments, be selected so as to be appealing to the eye of an infant, baby, or child.

In some embodiments of the present invention, one or more ribbing or ribbed elements (not pictured) may be provided on one or more of bottle 101 collar 102, nipple 103, cap 104, nipple tip 105, nipple neck 106, nipple base 107, or may comprise part or all of bottle 101, collar 102, nipple 103, cap 104, nipple tip 105, nipple neck 106, and nipple base 107, and may comprise one or more thermochromic elements such as but not limited to one or more thermochromic liquid crystals, leuco dyes, or a combination of thermochromic liquid crystals and leuco dyes. For example, the present invention may provide for a first ribbing, second ribbing, third ribbing, fourth ribbing, fifth ribbing, sixth ribbing, seventh ribbing, and/or eighth ribbing.

In some embodiments, the thermochromic elements of the ribbing elements may differ. For example, one or more of first ribbing, second ribbing, third ribbing, fourth ribbing, fifth ribbing, sixth ribbing, seventh ribbing, and eighth ribbing may provide for different thermochromic elements than another of first ribbing, second ribbing, third ribbing, fourth ribbing, fifth ribbing, sixth ribbing, seventh ribbing, and/or eighth ribbing. In some embodiments, each of first ribbing, second ribbing, third ribbing, fourth ribbing, fifth ribbing, sixth ribbing, seventh ribbing, and/or eighth ribbing may comprise a different thermochromic element from every other ribbing of first ribbing, second ribbing, third ribbing, fourth ribbing, fifth ribbing, sixth ribbing, seventh ribbing, and eighth ribbing.

In some embodiments, the differences in thermochromic elements between one or more of first ribbing, second ribbing, third ribbing, fourth ribbing, fifth ribbing, sixth ribbing, seventh ribbing, and eighth ribbing may provide for an escalating visual indication system wherein once all the ribbings have changed color, the infant formula is at the right temperature to give to an infant, baby, toddler, or child.

For example, by way of illustration and not limitation, when activated by sufficient thermal energy, first ribbing may change color to a light shade of pink, second ribbing may change to a slightly darker shade of pink, third ribbing may in turn change to a slightly darker shade of pink, fourth ribbing may change to an even darker shade of pink, fifth ribbing may change to a darker shade of pink still, sixth ribbing may change to a yet darker shade of pink, seventh ribbing may change to a very dark shade of pink, and eighth ribbing may change to a thoroughly dark shade of pink, as the fluid inside bottle changes, either in volume, temperature, or both.

In some embodiments, one or more thermochromic bands (not shown) may be positioned anywhere on one or more of bottle 101, collar 102, nipple 103, cap 104, nipple tip 105, nipple neck 106, nipple base 107, and/or any ribbing, or may comprise part or all of bottle 101, collar 102, nipple 103, cap 104, nipple tip 105, nipple neck 106, nipple base 107, and/or any ribbing. It is contemplated that whereas a ribbing may comprise a protrusion, recessed portion, or an element otherwise detectable by palpation, a thermochromic band may appear flush with the surface of the element on which it is disposed or which it comprises. In other embodiments, a thermochromic band may be visually or otherwise undetectable until the thermochromic band undergoes a temperature change coupled with a visual indicator.

Accordingly, one or more thermochromic bands may comprise one or more thermochromic elements such as but not limited to one or more thermochromic liquid crystals, leuco dyes, or a combination of thermochromic liquid crystals and leuco dyes. For example, the present invention may provide for a first thermochromic band, second thermochromic band, third thermochromic band, fourth thermochromic band, fifth thermochromic band, sixth thermochromic band, seventh thermochromic band, and/or eighth thermochromic band.

In some embodiments, the thermochromic elements of the thermochromic band elements may differ. For example, one or more of first thermochromic band, second thermochromic band, third thermochromic band, fourth thermochromic band, fifth thermochromic band, sixth thermochromic band, seventh thermochromic band, and eighth thermochromic band may provide for different thermochromic elements than another of first thermochromic band, second thermochromic band, third thermochromic band, fourth thermochromic band, fifth thermochromic band, sixth thermochromic band, seventh thermochromic band, and/or eighth thermochromic band. In some embodiments, each of first thermochromic band, second thermochromic band, third thermochromic band, fourth thermochromic band, fifth thermochromic band, sixth thermochromic band, seventh thermochromic band, and/or eighth thermochromic band may comprise a different thermochromic element from every other thermochromic band of first thermochromic band, second thermochromic band, third thermochromic band, fourth thermochromic band, fifth thermochromic band, sixth thermochromic band, seventh thermochromic band, and eighth thermochromic band.

In some embodiments, the differences in thermochromic elements between one or more of first thermochromic band, second thermochromic band, third thermochromic band, fourth thermochromic band, fifth thermochromic band, sixth thermochromic band, seventh thermochromic band, and eighth thermochromic band may provide for an escalating or graduated visual indication system wherein once all the thermochromic bands have changed color, the infant formula is at the right temperature to give to an infant, baby, toddler, or child.

For example, by way of illustration and not limitation, when activated by sufficient thermal energy, first thermochromic band may change color to a light shade of purple, second thermochromic band may change to a slightly darker shade of purple, third thermochromic band may in turn change to a slightly darker shade of purple, fourth thermochromic band may change to an even darker shade of purple, fifth thermochromic band may change to a darker shade of purple still, sixth thermochromic band may change to a yet darker shade of purple, seventh thermochromic band may change to a very dark shade of purple, and eighth thermochromic band may change to a thoroughly dark shade of purple, as the fluid inside bottle changes, either in volume, temperature, or both.

Remaining with FIG. 1, in some embodiments, graduated indicator 108 may comprise a vertically or lengthwise oriented thermometer-type indicator, as generally shown in FIG. 1. It is contemplated that graduated indicator 108 may comprise at least one thermochromic element. In some embodiments, graduated indicator 108 may be a spiral, diagonally oriented, or any other configuration. In some embodiments, more than one graduated indicator 108 may be provided. In embodiments with more than one graduated indicator 108, one or more graduated indicators 108 may comprise a different thermochromic element or elements than another graduated indicator 108.

Design element 109 is provided in FIG. 1 as illustrative examples only. For example, in addition to or in substitution for a football, soccer ball, volley ball, or basketball as shown in FIG. 1, design element 109 may comprise an image, such as a rainbow, a train, or a monkey, or a design, such as a series of lines. Design element 109 could also comprise a letter, or even an image or outline of an object, person, or person's face.

Collar upper portion 110 may be configured, in some embodiments, to secure one or more of nipple 103, nipple tip 105, nipple neck 106, and/or nipple base 107 to bottle 101. Additionally, collar upper portion 110 may be configured to receive one or more edges or portions of cap 104.

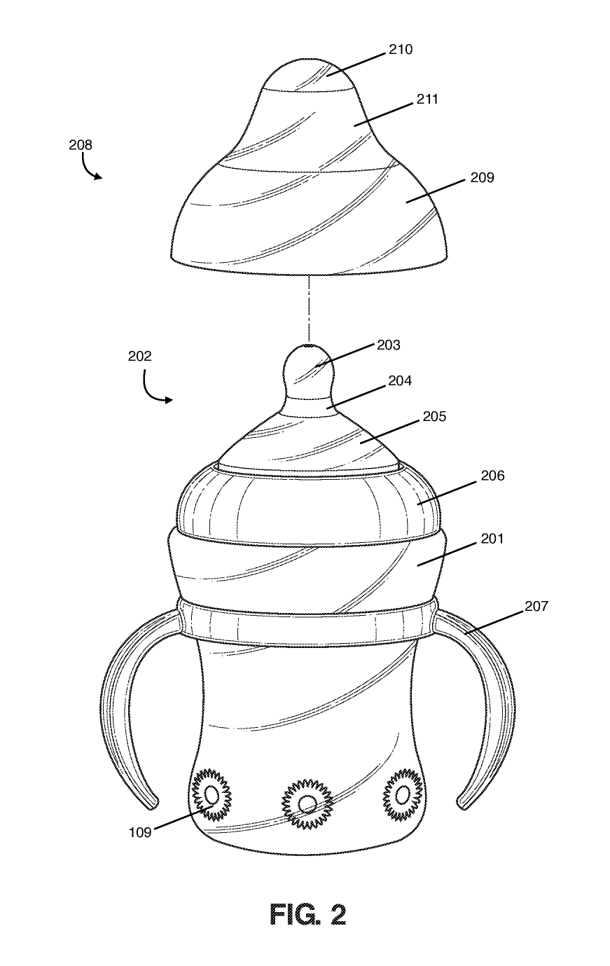

Turning attention to FIG. 2, a front perspective view of a thermochromic baby bottle in accordance with an embodiment of the invention is generally disclosed. Notably, in the non-limiting embodiment generally disclosed in FIG. 2, a viewer may perceive short bottle 201, short bottle nipple 202, short bottle nipple tip 203, short bottle nipple midsection 204, short bottle nipple base 205, short bottle collar 206, wings handle 207, short bottle cap 208, short bottle cap base 209, short bottle cap top 210, short bottle cap midsection 211, and design element 109.

Short bottle 201 in some embodiments may have an hourglass shape, as generally shown in FIG. 2. However, in some embodiments, short bottle 201 may comprise a cylinder, a sphere, an animal shape such as but not limited to a monkey, lion, rabbit or a dog, an object such as a banana, tree, flower, star, sun, or moon, a rocket ship or train. Any object commonly known to be appealing to children is contemplated herein as a shape for short bottle 201, bottle 101, or any other element of the present invention. Short bottle 201 may comprise one or more central cavities. In some embodiments, short bottle 201 may comprise two or more cavities. In some embodiments, short bottle 201 may comprise two or more connected cavities. Short bottle 201 may provide for any limitation of bottle 101 or any other bottle of the present invention. As well, short bottle 201 may be comprised of any material known in the art, such as but not limited to glass, any plastic, latex, elastomer, silicone, synthetic elastomer, a disposable material, a natural fiber, stainless steel, carbon fiber, wood, ceramic, or a combination of any such material.

Short bottle nipple 202 may be shaped as a natural-looking nipple, such as by way of illustration and not limitation an orthodontic-shaped short bottle nipple 202, a round-shaped short bottle nipple 202, a bell-shaped short bottle nipple 202, a dome-shaped short bottle nipple 202, and may be configured for slow flow, medium flow, or fast flow.

In some embodiments, short bottle nipple 202 may comprise one or more of short bottle nipple tip 203, short bottle nipple midsection 204, and short bottle nipple base 205. Other elements may comprise short bottle nipple 202 as well, such as but not limited to one or more perforations, one or more raised portions and one or more recessed portions.

As can be seen in FIG. 2, short bottle nipple 202 may generally comprise a nipple wherein short bottle nipple base 205 is wide relative to short bottle nipple tip 203 and short bottle nipple midsection 204. However, in some embodiments, any of short bottle nipple tip 203, short bottle nipple midsection 204, and short bottle nipple base 205 may be wider or narrower relative to each other than generally shown in FIG. 2. For example, in some embodiments, short bottle nipple tip 203, short bottle nipple midsection 204, and short bottle nipple base 205 may comprise more of a cylinder, or short bottle nipple tip 203 and short bottle nipple midsection 204 may be wider than short bottle nipple base 205. Or short bottle nipple midsection 204 may flare out wider than one or more of short bottle nipple tip 203 and short bottle nipple base 205.

Generally, short bottle nipple 202, short bottle nipple tip 203, short bottle nipple midsection 204, and short bottle nipple base 205 may be comprised of latex, elastomer, a soft plastic, silicone, synthetic elastomer, or any other material named herein or known in the art.

In some embodiments, short bottle nipple 202, short bottle nipple tip 203, short bottle nipple midsection 204, and/or short bottle nipple base 205 may be comprised of one or more thermochromic elements. For example, in some embodiments short bottle nipple 202, short bottle nipple tip 203, short bottle nipple midsection 204, and/or short bottle nipple base 205 may provide for a thermochromic element configured to change color when a fluid such as infant formula flows through short bottle nipple 202, short bottle nipple tip 203, short bottle nipple midsection 204, and/or short bottle nipple base 205 at a particular temperature. In some embodiments, one or more of short bottle nipple 202, short bottle nipple tip 203, short bottle nipple midsection 204, and/or short bottle nipple base 205 may provide for different thermochromic elements such that short bottle nipple 202, short bottle nipple tip 203, short bottle nipple midsection 204, and/or short bottle nipple base 205 may be configured to give more specific visual information to a user as to the approximate or even nearly-exact temperature of the fluid flowing through short bottle nipple 202, short bottle nipple tip 203, short bottle nipple midsection 204, and/or short bottle nipple base 205.

Short bottle collar 206 is shown in FIG. 2 as curving inward towards short bottle 201, but in some embodiments, short bottle collar 206 may curve less, may extend straight up, or may curve outward, relative to the midlines of short bottle 101 and short bottle nipple 202. Short bottle collar 206 may also be wider or narrower, taller or shorter, thicker or thinner than generally depicted in FIG. 2. It is contemplated that in some embodiments, short bottle collar 206 may be configured to threadedly attach to threads disposed on the top portion of short bottle 201, and in some embodiments may be configured to threadedly attach to threads disposed on the top portion of bottle 101 as well.

Wings handle 207 may, in some embodiments, be comprised as two arcuate extensions that curve outward from a central ring. In some embodiments, the ring of wings handle 207 may be affixed either permanently or removably to the perimeter of short bottle 201. In embodiments wherein the ring of wings handle 207 is configured to threadedly attach to the top or sides, or both, of short bottle 201, several possible threading locations exist. For example, the ring of wings handle 207 may threadedly attach to the top of short bottle collar 206, to threads (not shown) on the top of short bottle 201 that enable short bottle collar 206 to threadedly attach to short bottle 201, or to threads on the outside of short bottle 201 (also not shown). In embodiments wherein the ring of wings handle 207 is configured to threadedly attach to the same threads of short bottle 201 to which short body collar 206 threadedly attached, it is contemplated that wings handle 207 may threadedly attach to the threads and short body collar 206 may threadedly attach on top of wings handle 207 using the remaining threads. Of course, those of skill in the art will recognize that any configuration is possible, such as but not limited to embodiments wherein short body collar 206 threadly attaches as described and wings handle 207 threadedly attaches on top of short body collar 206 using the remaining threads.

The elongated “wings” portions of wings handle 207 may vary from embodiment to embodiment as well. For example, in some embodiments, wings handle 207 may comprise two handles curving away from a central ring. In other embodiments, one, two, three or more wings may be so positioned on wings handle 207. Additionally, one or more of the handles of wings handle 207 may be longer or shorter than shown in FIG. 2. As well, wings handle 207 may comprise one or more thermochromic elements, one or more design elements, one or more illumination elements, or any other aesthetic or functional feature.

Short bottle cap 208, short bottle cap base 209, short bottle cap top 210, short bottle cap midsection 211 may also comprise any shape known in the art, in addition to or in substitution for the shape disclosed in FIG. 2. For example, in addition to the approximately bell-shaped short bottle cap 208 generally depicted in FIG. 2, short bottle cap 208 may approximate a cylinder having one opening, a pyramid, a sphere, or any other shape known in the art. Relatedly, any of short bottle cap base 209, short bottle cap top 210, and short bottle cap midsection 211 may be of any size relationship relative to each other or to another element of thermochromic baby bottle 100.

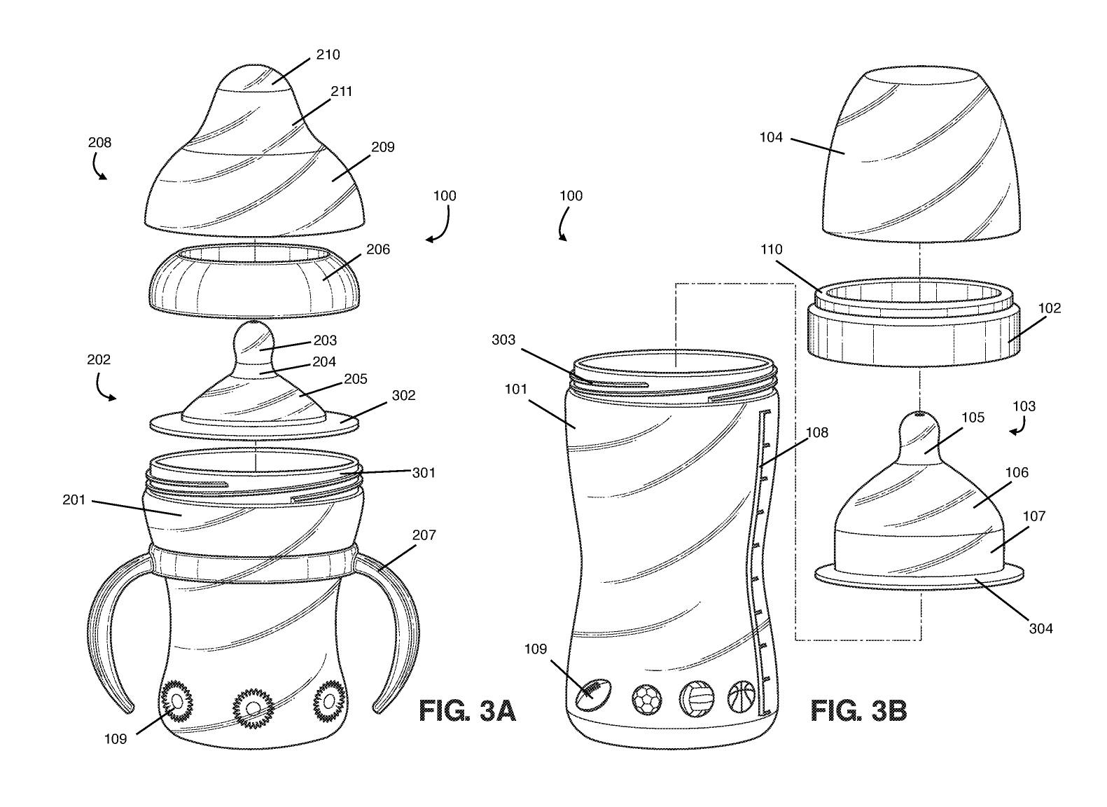

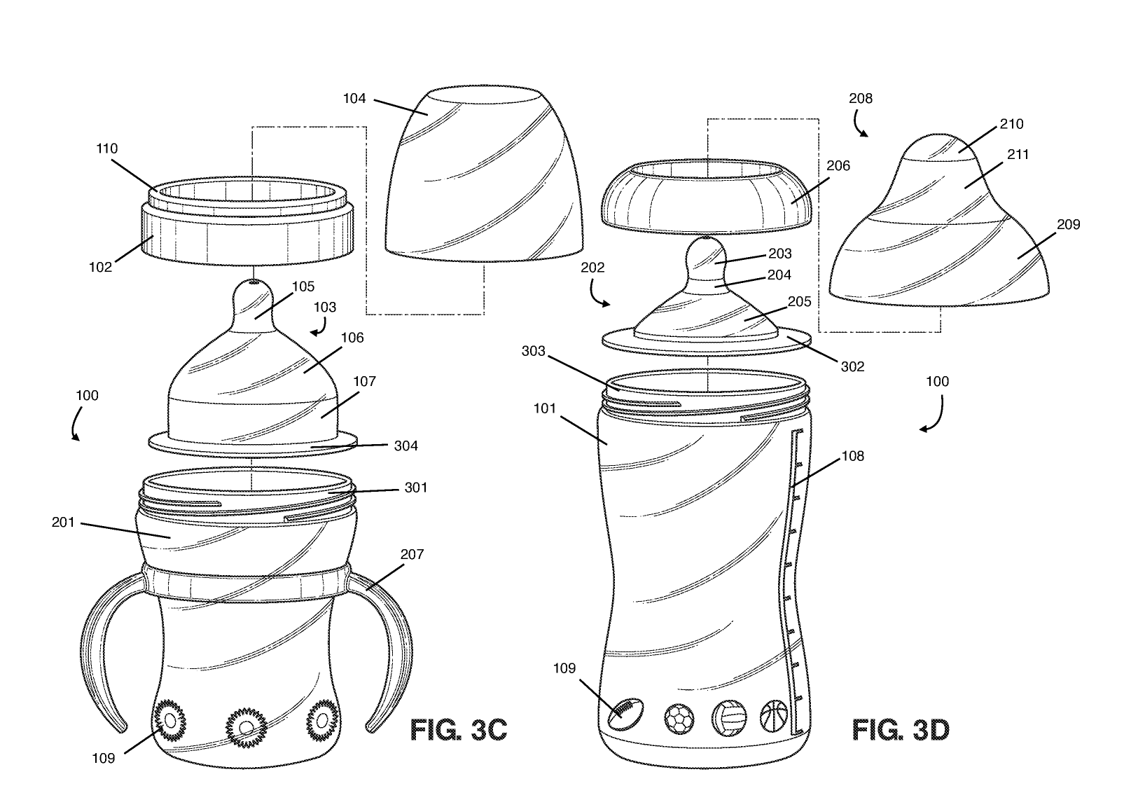

With respect to FIG. 3A, an exploded view of a thermochromic baby bottle in accordance with an embodiment of the invention may generally be perceived. In the embodiment depicted, a user may perceive short bottle threads 301 and short bottle nipple lip 302, as well as short bottle 201, short bottle nipple 202, short bottle nipple tip 203, short bottle nipple midsection 204, short bottle nipple base 205, short bottle collar 206, wings handle 207, short bottle cap 208, short bottle cap base 209, short bottle cap top 210, short bottle cap midsection 211, and design element 109.

In some embodiments, short bottle threads 301 may be more numerous or fewer than shown in FIG. 3A, more may be more densely or sparsely separated or provided. In some embodiments, short bottle threads 301 may instead be a snap-on connection element, a magnetized connection element, a hook and loop fastening element, a friction or suction-powered connection element, or any such equivalents.

As may be perceived by those of skill in the art, generally, short bottle nipple lip 302 may be wider or narrower, thicker or thinner, depending on a number of factors, including the configuration(s) of short bottle nipple 202, short bottle nipple base 205, short bottle collar 206, or any other element of thermochromic baby bottle 100.

Moving to a consideration of FIG. 3B, an exploded view of a thermochromic baby bottle in accordance with an embodiment of the invention may generally be perceived. In the embodiment depicted, a viewer may perceive bottle threads 303 and bottle nipple lip 304, as well as bottle 101, collar 102, nipple 103, cap 104, nipple tip 105, nipple neck 106, nipple base 107, graduated indicator 108, design element 109, and collar upper portion 110.

Similar to one or more elements described above, in some embodiments, bottle threads 303 may be more numerous or fewer than shown in FIG. 3B, more may be more densely or sparsely dispersed on bottle 101. In some embodiments, bottle threads 303 may instead be a snap-on connection element, a magnetized connection element, a hook and loop fastening element, a friction or suction-powered connection element, or any such equivalents.

As may be perceived by those of skill in the art, generally, nipple lip 303 may be wider or narrower, or thicker or thinner, depending on a number of factors, including the configuration(s) of nipple 103, nipple base 107, collar 102, or any other element of thermochromic baby bottle 100.

With reference to FIG. 3C, an exploded view of a thermochromic baby bottle in accordance with an embodiment of the invention may generally be perceived. In the embodiment depicted, thermochromic baby bottle 100, collar 102, nipple 103, cap 104, nipple tip 105, nipple neck 106, nipple base 107, design element 109, collar upper portion 110, short bottle 201, wings handle 207, short bottle threads 301, and bottle nipple lip 304 are depicted.

Generally, in some embodiments, one or more elements of the present invention may be interchangeable with one or more other elements of the present invention. As can be seen, for example, in FIG. 3C, in some embodiments the collar 102, nipple 103, cap 104, nipple tip 105, nipple neck 106, nipple base 107, and collar upper portion 110 associated with bottle 101 in FIG. 1 may, in some embodiments, be configured for use with short bottle 201 and wings handle 207.

In FIG. 3D, an exploded view of a thermochromic baby bottle in accordance with an embodiment of the invention may generally be perceived. In the embodiment depicted, a viewer may perceive thermochromic baby bottle 100, bottle 101, graduated indicator 108, design element 109, short bottle nipple 202, short bottle nipple tip 203, short bottle nipple midsection 204, short bottle nipple base 205, short bottle collar 206, short bottle cap 208, short bottle cap base 209, short bottle cap top 210, short bottle cap midsection 211, short bottle nipple lip 302, as well as nipple lip 303.

FIG. 3D, like FIG. 3C, serves to illustrate how in some embodiments, one or more elements of the present invention may be interchangeable with one or more other elements of the present invention. As can be seen, for example, in FIG. 3D, in some embodiments the short bottle nipple 202, short bottle nipple tip 203, short bottle nipple midsection 204, short bottle nipple base 205, short bottle collar 206, short bottle cap 208, short bottle cap base 209, short bottle cap top 210 and short bottle cap midsection 211 associated with short bottle 201 in FIG. 2 may, in some embodiments, be configured for use with bottle 101.

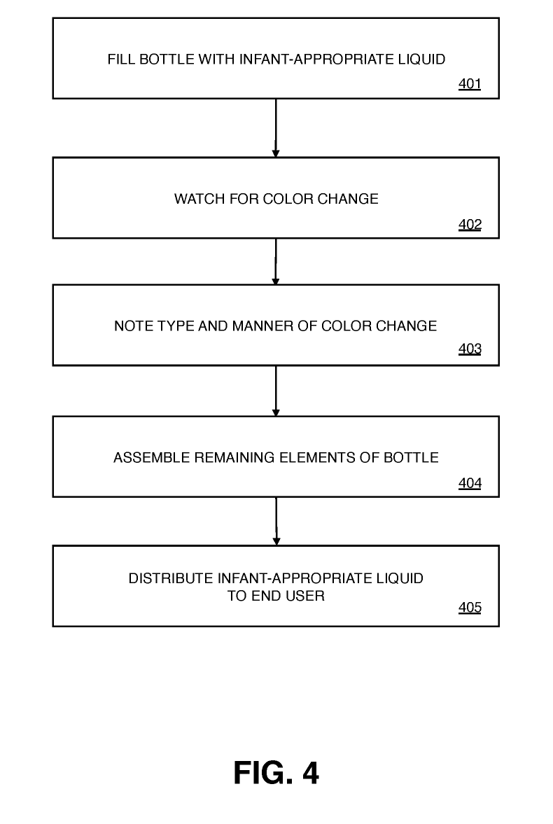

Turning attention to FIG. 4, a method of use for a thermochromic baby bottle in accordance with an embodiment of the invention is disclosed. In some embodiments, the method comprises filling the bottle with an infant-appropriate liquid having a temperature 401. Next, a user may watch for a color change in the present invention 402, and observe if possible the one or more thermochromic elements disposed on or within one or more elements of the present invention, such as but not limited to the bottle or the nipple. Should the thermochromic element undergo a color change, a user may note the color and manner of the color change 403, if any. If and when thermal energy from the infant appropriate liquid causes at least one thermochromic element to undergo a color change, a user may observe the color change and determine that infant-appropriate liquid is of the right temperature for administration to an end user, such as but not limited to an infant, baby, toddler, child, teenager, adult, or senior. A user may then assemble the remaining portions of the bottle 405, such as but not limited to threadedly attaching the collar to the bottle overtop of the nipple, so as to hold the nipple in place and allow the liquid to flow through the nipple. Once the bottle is assembled, the user may distribute the infant-appropriate liquid to an end user by enabling the end user to suckle the nipple 405.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While specific embodiments of, and examples for, the present invention are described above for illustrative purposes, various equivalent modifications are possible for which those skilled in the relevant art will recognize.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A thermochromic baby bottle, comprising:
at least one bottle, comprising:
a) at least one bottom portion;
b) at least one wall disposed on the bottom portion, the at least one wall having an exterior wall side and an interior wall side;
c) at least one thermochromic element disposed within the at least one wall;
d) at least one top portion comprising at least one top edge of the at least one wall, the at least one top edge defining at least one top opening in the top portion;
e) at least one threaded element disposed along at least a portion of the top portion; and
f) at least one bottle cavity comprising at least part of an area defined by the at least one bottle wall interior, and wherein the at least one bottle cavity opens to the top opening;
at least one nipple having at least one nipple lip and at least one nipple tip, wherein the at least one nipple lip has a nipple lip circumference, wherein the at least one nipple lip is configured to lay against the at least one top edge;
at least one bottle collar defining at least one bottle collar opening having a bottle collar opening circumference, wherein the at least one bottle collar is configured to threadedly attach to the at least one threaded element, and wherein the at least one bottle collar circumference is less than the at least one nipple lip circumference; and
at least one cap configured to cover the at least one nipple and removably attach to the at least one bottle collar.

2. The thermochromic baby bottle of claim 1, wherein the at least one thermochromic element comprises:
a) a first thermochromic element having at least one first thermochromic property; and
b) a second thermochromic element having at least one second thermochromic property, wherein the first thermochromic element is disposed within the at least one bottle closer to the at least one bottom portion than the second thermochromic element, and wherein the first thermochromic property differs from the at least one second thermochromic property.

3. The thermochromic baby bottle of claim 2, further comprising a third thermochromic element having at least one third thermochromic property, wherein the first thermochromic element is disposed within the at least one bottle closest to the at least one bottom, the second thermochromic element is disposed within the at least one bottle closest to the at least one top portion, and the third thermochromic element is disposed within the at least one bottle between the first thermochromic element and the second thermochromic element, and wherein the at least one first thermochromic property, the at least one second thermochromic property, and the at least one third thermochromic property differ from each other.

4. The thermochromic baby bottle of claim 1, further comprising at least one nipple thermochromic element disposed within the at least one nipple.

5. The thermochromic baby bottle of claim 4, wherein the at least one nipple thermochromic element comprises:
a) a first nipple thermochromic element having at least one first nipple thermochromic property; and
b) a second nipple thermochromic element having at least one second nipple thermochromic property, wherein the first nipple thermochromic element is disposed within the at least one nipple closer to the at least one nipple lip than the second nipple thermochromic element, and wherein the at least one first nipple thermochromic property differs from the at least one second nipple thermochromic property.

6. The thermochromic baby bottle of claim 5, further comprising a third thermochromic nipple element having at least one third nipple thermochromic property, wherein the first nipple thermochromic element is disposed within the at least one nipple closest to the at least one nipple lip, the second nipple thermochromic element is disposed within the at least one nipple closest to the at least one nipple tip, and the third nipple thermochromic element is disposed within the at least one nipple between the first thermochromic element and the second thermochromic element, and wherein the at least one first nipple thermochromic property, the at least one second nipple thermochromic property, and the at least one third nipple thermochromic property differ from each other.

7. The thermochromic baby bottle of claim 1, further comprising a wings-shaped handle configured to removably attach on the exterior wall side.

8. The thermochromic baby bottle of claim 1, further comprising at least one thermochromic design element disposed on the exterior wall side.

9. The thermochromic baby bottle of claim 1, wherein the at least one wall is configured in an hourglass shape.

10. The thermochromic baby bottle of claim 1, wherein the at least one nipple is configured as a natural-shaped nipple.

11. A method of using a thermochromic baby bottle, comprising:
providing at least one bottle, comprising:
a) at least one bottom portion;
b) at least one wall disposed on the bottom portion, the at least one wall having an exterior wall side and an interior wall side;
c) at least one thermochromic element disposed within the at least one wall;
d) at least one top portion comprising at least one top edge of the at least one wall, the at least one top edge defining at least one top opening in the top portion;
e) at least one threaded element disposed along at least a portion of the top portion; and
f) at least one bottle cavity comprising at least part of an area defined by the at least one bottle wall interior, and wherein the at least one bottle cavity opens to the top opening;
providing at least one nipple having at least one nipple lip and at least one nipple tip, wherein the at least one nipple lip has a nipple lip circumference, wherein the at least one nipple lip is configured to lay against the at least one top edge;
providing at least one bottle collar defining at least one bottle collar opening having a bottle collar opening circumference, wherein the at least one bottle collar is configured to threadedly attach to the at least one threaded element, and wherein the at least one bottle collar circumference is less than the at least one nipple lip circumference;
providing at least one cap configured to cover the at least one nipple and removably attach to the at least one bottle collar;
filling the at least one bottle cavity with an infant-appropriate liquid having a liquid temperature;
observing at least one change in the at least one thermochromic element, wherein the at least one change indicates that the liquid temperature is desirable;
placing the at least one nipple on top of the at least one top edge such that the at least one nipple lip rests on the at least one top edge and the at least one nipple tip is pointed away from the at least one bottle;
placing the at least one bottle collar over the at least one nipple such that the at least one bottle collar opening surrounds the at least one nipple and the portion of the at least one bottle collar that defines the at least one bottle collar opening rests on the at least one nipple lip;
threadedly attaching the at least one bottle collar to the at least one threaded element, thereby securing the at least one nipple against the at least one top edge; and
inverting the at least one bottle such that the infant-appropriate liquid flows through the at least one nipple.

12. The method of claim 11, wherein the at least one thermochromic element comprises:
a) a first thermochromic element having at least one first thermochromic property; and
b) a second thermochromic element having at least one second thermochromic property, wherein the first thermochromic element is disposed within the at least one bottle closer to the at least one bottom portion than the second thermochromic element, and wherein the first thermochromic property differs from the at least one second thermochromic property.

13. The method of claim 12, further comprising a third thermochromic element having at least one third thermochromic property, wherein the first thermochromic element is disposed within the at least one bottle closest to the at least one bottom, the second thermochromic element is disposed within the at least one bottle closest to the at least one top portion, and the third thermochromic element is disposed within the at least one bottle between the first thermochromic element and the second thermochromic element, and wherein the at least one first thermochromic property, the at least one second thermochromic property, and the at least one third thermochromic property differ from each other.

14. The method of claim 11, further comprising at least one nipple thermochromic element disposed within the at least one nipple.

15. The method of claim 14, wherein the at least one nipple thermochromic element comprises:
a) a first nipple thermochromic element having at least one first nipple thermochromic property; and
b) a second nipple thermochromic element having at least one second nipple thermochromic property, wherein the first nipple thermochromic element is disposed within the at least one nipple closer to the at least one nipple lip than the second nipple thermochromic element, and wherein the at least one first nipple thermochromic property differs from the at least one second nipple thermochromic property.

16. The method of claim 15, further comprising a third thermochromic nipple element having at least one third nipple thermochromic property, wherein the first nipple thermochromic element is disposed within the at least one nipple closest to the at least one nipple lip, the second nipple thermochromic element is disposed within the at least one nipple closest to the at least one nipple tip, and the third nipple thermochromic element is disposed within the at least one nipple between the first thermochromic element and the second thermochromic element, and wherein the at least one first nipple thermochromic property, the at least one second nipple thermochromic property, and the at least one third nipple thermochromic property differ from each other.

17. The method of claim 11, further comprising a wings-shaped handle configured to removably attach on the exterior wall side.

18. The method of claim 11, further comprising at least one thermochromic design element disposed on the exterior wall side.

19. The method of claim 11, wherein the at least one wall is configured in an hourglass shape.

20. The method of claim 11, wherein the at least one nipple is configured as a natural-shaped nipple.
